(19) United States
(12) Patent Application Publication
(10) Pub. No.: US 2022/0089884 A1
(43) Pub. Date: Mar. 24, 2022

(54) METHOD FOR DEBONDING DEBONDABLE COATING FILM AND ARTICLE

(71) Applicant: NITTO DENKO CORPORATION, Ibaraki-shi, Osaka (JP)

(72) Inventors: Kazuya FUJIOKA, Ibaraki-shi, Osaka (JP); Tomonari NAITO, Ibaraki-shi, Osaka (JP)

(21) Appl. No.: 17/418,339

(22) PCT Filed: Dec. 24, 2019
(86) PCT No.: PCT/JP2019/050574

§ 371 Date: Jun. 25, 2021

(30) Foreign Application Priority Data
Dec. 26, 2018 (JP) 2018-242673

(51) Int. Cl. C09D 5/20; B05D 3/12

(52) U.S. Cl. CPC C09D 5/20; B05D 3/12

(57) ABSTRACT

The present invention relates to a method for peeling off a strippable coating film formed on a surface of an adherend, including: a first step of preliminarily putting a trigger part in contact with at least a part of the surface of the adherend between the strippable coating film and the adherend; a second step of removing the trigger part so as to break at least a part of the strippable coating film; and a third step of peeling off the strippable coating film by using, as a trigger, a broken portion of the strippable coating film.

### TECHNICAL FIELD

The present invention relates to a method for peeling off a strippable coating film, and an article including a strippable coating film.

### BACKGROUND ART

In the related art, a method for protecting the surface of a structure with an antifouling coating film is used in order to prevent adhesion of dirt and to prevent scratches to the structure.

The antifouling coating film is required to adhere to the structure until a predetermined timing, to protect the surface, and to be easily peeled off if necessary. However, when the antifouling coating film that has been used for many years is repainted, it is necessary to remove the old antifouling coating film. The work of removing the old antifouling coating film causes a heavy labor such as polishing of the antifouling coating film is a high cost.

Therefore, studies on the peeling-off of the coating film have been promoted. For example, Patent Literature 1 describes a coating film that is easily strippable into a sheet shape and can facilitate the removal work.

In addition, Patent Literature 2 proposes a peeling-off method in which a margin for the peeling-off is allowed to adhere onto a strippable coating film, and the margin for the peeling-off is pulled to peel off the strippable coating film and unnecessary paint deposits deposited on the strippable coating film.

### CITATION LIST

### Patent Literature

Patent Literature 1: JP-A-2018-59084

Patent Literature 2: JP-A-2012-170831

### SUMMARY OF INVENTION

### Technical Problem

The antifouling coating film has a problem that it is difficult to peel off the antifouling coating film when the antifouling coating film is tried to be peeled off. The reason is that the antifouling coating film protects a structure and the structure is used while being protected by the antifouling coating and thus the antifouling coating film has excellent adhesion and durability. For example, the coating film that is easily peeled off into a sheet shape described in Patent Literature 1 has strong adhesion to an adherend and it is difficult to be peeled off as the adhesion area becomes larger, and thus development on a method for peeling off an antifouling coating film that can improve workability has been desired.

Further, according to the peeling-off method described in Patent Literature 2, the strippable coating film is peeled off by pulling the margin for the peeling-off, and thus the margin for the peeling-off may come off from the strippable coating film. Further, it is necessary to allow the margin for the peeling-off and the strippable coating film to bond to each other with a high adhesive force. This causes a problem that it is complicated to select materials such a tape or an adhesive which allows the margin for the peeling-off and the strippable film to bond to each other.

Therefore, the present invention has been made to solve the above problems, and an object thereof is to provide a peeling-off method capable of improving the workability of peeling off a coating film that is easily strippable into a sheet shape.

### Solution to Problem

That is, one embodiment of the present invention relates to a method for peeling off a strippable coating film formed on a surface of an adherend, comprising: a first step of preliminarily putting a trigger part in contact with at least a part of the surface of the adherend between the strippable coating film and the adherend; a second step of removing the trigger part so as to break at least a part of the strippable coating film; and a third step of peeling off the strippable coating film by using, as a trigger, a broken portion of the strippable coating film.

In a preferable embodiment of the method for peeling off a strippable coating film, the first step may include a step of putting the trigger part on the surface of the adherend, a step of coating a composition for forming a strippable coating film onto the surface of the adherend so as to cover at least a part of the trigger part, and a step of drying the composition for forming a strippable coating film to form the strippable coating film.

In another preferable embodiment of the method for peeling off a strippable coating film, the first step includes a step of coating a composition for forming a strippable coating film onto the surface of the adherend, a step of embedding the trigger part in the composition for forming a strippable coating film such that the adherend and at least a part of the trigger part are in contact with each other, and a step of drying the composition for forming a strippable coating film to form the strippable coating film.

In the method for peeling off a strippable coating film, the trigger part is preferably put while leaving an extension portion in the first step.

In the method for peeling off a strippable coating film, the trigger part is preferably strip-shaped, tape-shaped, or linear.

In the method for peeling off a strippable coating film, a tensile elastic modulus of the trigger part is preferably larger than a tensile elastic modulus of the strippable coating film.

In the method for peeling off a strippable coating film, the strippable coating film may contain an elastomer.

In the method for peeling off a strippable coating film, the strippable coating film may be broken into two or more by the second step.

Another embodiment of the present invention relates to an article comprising: an adherend; a trigger part in contact with at least a part of the surface of the adherend; and a strippable coating film formed on the adherend and the trigger part, wherein at least a part of the strippable coating film is breakable by removing the trigger part, and the strippable coating film contains an elastomer.

### Advantageous Effects of Invention

The present invention allows for providing a peeling-off method and an article capable of improving the workability of peeling off a sheet strippable coating film.

### BRIEF DESCRIPTION OF DRAWINGS

FIG. 1 is a schematic diagram illustrating a method for peeling off a strippable coating film according to a first embodiment of the present invention.

FIG. 2 is a schematic diagram illustrating the method for peeling off a strippable coating film according to the first embodiment of the present invention.

FIG. 3 is a cross-sectional view taken along a line A-A′ illustrating the method for peeling off a strippable coating film in FIG. 2.

FIG. 4 is a schematic diagram illustrating the method for peeling off a strippable coating film according to the first embodiment of the present invention.

FIG. 5 is a schematic diagram illustrating a method for peeling off a strippable coating film according to a second embodiment of the present invention.

FIG. 6 is a schematic diagram illustrating the method for peeling off a strippable coating film according to the second embodiment of the present invention.

FIG. 7 is a schematic diagram illustrating the method for peeling off a strippable coating film according to the second embodiment of the present invention.

FIG. 8 is a top view illustrating a method for peeling off a strippable coating film according to a third embodiment of the present invention.

FIG. 9 is a cross-sectional view taken along a line B-B′ illustrating the method for peeling off a strippable coating film in FIG. 8.

FIG. 10 is a cross-sectional view illustrating a step after FIG. 9.

FIG. 11 is a schematic diagram illustrating the method for peeling off a strippable coating film according to the third embodiment of the present invention.

### DESCRIPTION OF EMBODIMENTS

Hereinafter, embodiments of the present invention will be described in detail. It should be noted that the present invention is not limited to the embodiments described below, and can be optionally changed without departing from the scope of the present invention.

[Method for Peeling Off Strippable Coating Film]

A method for peeling off a strippable coating film according to an embodiment of the present invention is a method for peeling off a strippable coating film formed on a surface of an adherend, and includes: a first step of preliminarily putting a trigger part in contact with at least a part of the surface of the adherend between the strippable coating film and the adherend; a second step of removing the trigger part and breaking at least a part of the strippable coating film; and a third step of peeling off the strippable coating film by using, as a trigger, a broken portion of the strippable coating film.

Here, the strippable coating film refers to a coating film that can be peeled off into a sheet shape without cracking. The strippable coating film can be formed by coating and drying a composition for forming a strippable coating film, and is strippable into a sheet shape, so that the removal work can be facilitated.

The first step may include a step of putting the trigger part on the surface of the adherend, a step of coating a composition for forming a strippable coating film onto the surface of the adherend so as to cover at least a part of the trigger part, and a step of drying the composition for forming a strippable coating film to form the strippable coating film.

### First Embodiment

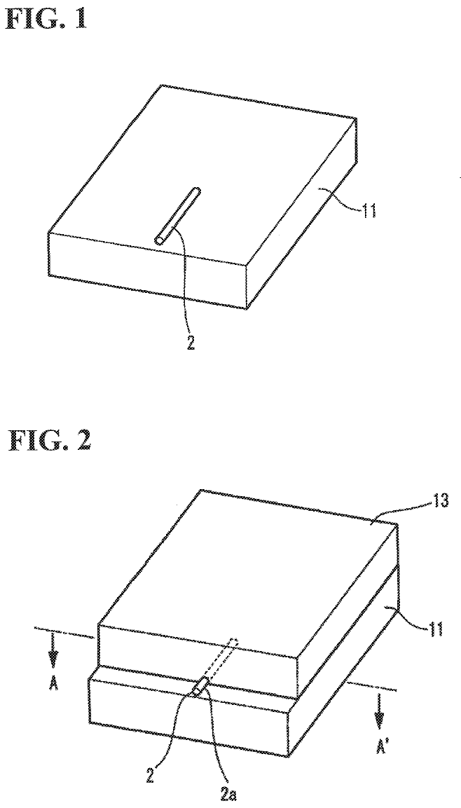

FIGS. 1 to 4 are schematic diagrams illustrating, in order, a method for peeling off a strippable coating film according to a first embodiment of the present invention.

[First Step]

As shown in FIG. 1, a trigger part 2 is put on a part of the surface of an adherend 11 (trigger part putting step). The trigger part 2 is a part that creates a trigger for peeling off the strippable coating film to be formed later, and can be put on a part of the surface of the adherend 11 preliminarily. The shape and material of the trigger part will be described in detail later. Thereafter, as shown in FIG. 2, a composition for forming a strippable coating film is coated using a coating tool such as an air spray gun, a brush, or a roller so as to cover the surface of the adherend 11 and a part of the trigger part 2 (coating step), and is dried to form a strippable coating film 13 (coating film forming step).

Further, in the first step, the trigger part is preferably put while an extension portion 2a is left. Leaving the extension portion 2a when the trigger part is put makes it easier to remove the trigger part and improves the workability. The extension portion 2a is a portion where the trigger part 2 extends from the strippable coating film. As illustrated in FIG. 1 and FIG. 2, the extension portion 2a may extend in parallel with the spreading direction of the surface of the adherend. The extending direction is not limited but the extension portion 2a may extend in another direction.

When the trigger part 2 is put, an adhesive tape or the like may be used to fix the trigger part 2 to the surface of the adherend 11.

[Second Step]

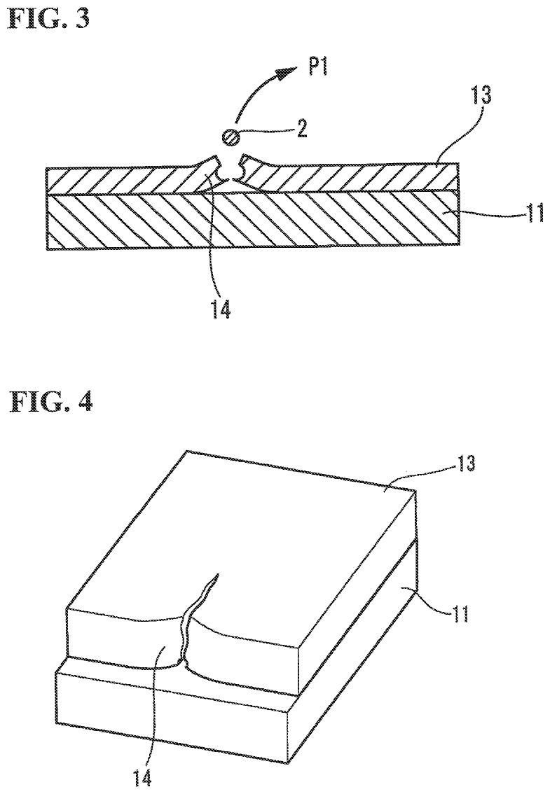

The trigger part 2 is removed so as to break at least a part of the strippable coating film 13, as shown in FIG. 4 by pulling the extension portion 2a of the trigger part 2 in a direction indicated by an arrow P1 as shown in FIG. 3.

[Third Step]

Thereafter, the strippable coating film 13 is peeled off from the adherend 11 by pulling a broken portion 14 of the strippable coating film 13.

The peeling-off method of the first embodiment described above allows the strippable coating film 13 to be easily peeled off from the adherend by using the broken portion 14 as a trigger. The broken portion 14 is formed by the breaking of a part of the strippable coating film 13 when the trigger part 2 is removed. In addition, when the trigger part 2 is removed, a part of the strippable coating film 13 is peeled off from the adherend 11. As a result, the part can be a trigger for the peeling-off, and the work efficiency can be improved.

### Second Embodiment

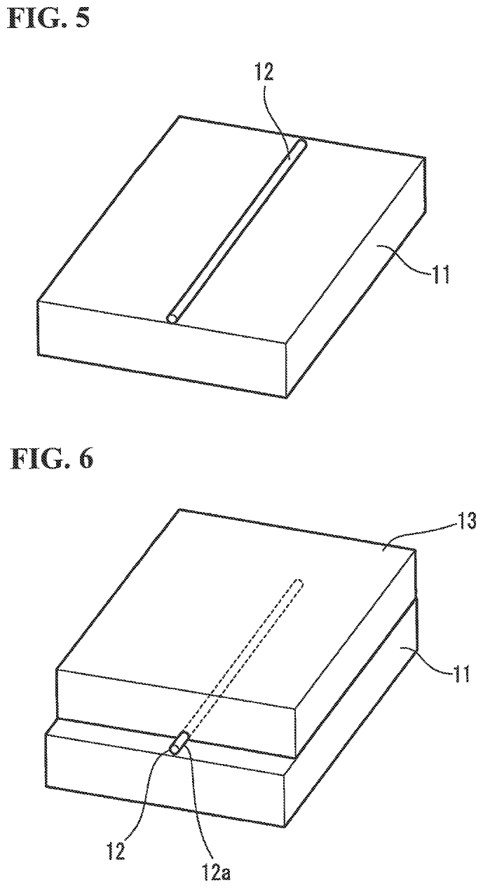

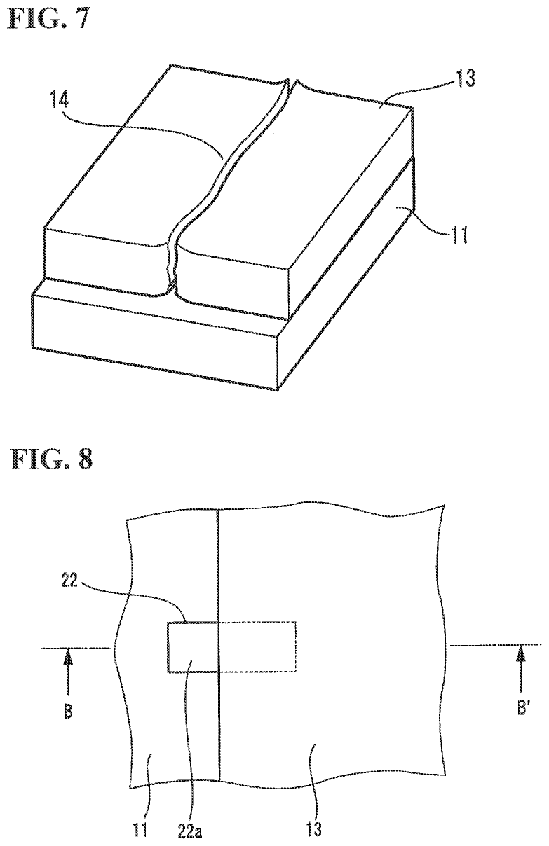

FIGS. 5 to 7 show a method for peeling off a strippable coating film according to a second embodiment of the present invention. In FIG. 6, same objects as those in FIG. 2 are designated by the same reference numerals, and detailed description thereof will be omitted. The second embodiment will be described below.

[First Step]

As shown in FIGS. 5 and 6, as the first step, a trigger part 12 is put on a part of the surface of the adherend 11, a composition for forming a strippable coating film is coated using a coating tool such as an air spray gun, a brush, or a roller so as to cover the surface of the adherend 11 and a part of the trigger part 12, and is then dried to form the strippable coating film 13.

[Second Step]

As the second step, the trigger part 12 is removed so as to break the strippable coating film 13.

[Third Step]

Thereafter, as the third step, as shown in FIG. 7, the strippable coating film 13 is peeled off from the adherend 11 by using, as a trigger, the broken portion 14 formed by breaking the strippable coating film 13 when the trigger part 12 is removed.

The peeling-off method of the second embodiment described above allows for the strippable coating film 13 to be more easily peeled off from the adherend 11 due to the reduction of the area of the strippable coating film 13, because the strippable coating film 13 is broken into two when the trigger part 12 is removed.

In the first and second embodiments, the trigger part 2, 12 is put such that the longitudinal direction of the thread-like trigger part 2, 12 is perpendicular to the end portion of the strippable coating film 13, but the shape, number, and putting direction of the trigger part 2, 12 are not limited. A plurality of the trigger parts 2, 12 may be put in any direction, and the strippable coating film 13 may be broken into two or more by removing the trigger parts 2, 12. For example, the trigger parts 2, 12 may be put in a manner where the trigger parts are crossed. The strippable coating film 13 has high adhesion to the adherend 11, and thus, when the area is large, a large force is required when the strippable coating film 13 is peeled off from the adherend 11. Dividing the strippable coating film 13 reduces the area of the strippable coating film 13 and the force required for peeling off the strippable coating film 13 from the adherend 11, so that the workability is improved.

The first step may include a step of coating a composition for forming a strippable coating film onto the surface of the adherend, a step of embedding the trigger part in the composition for forming a strippable coating film such that the adherend and at least a part of the trigger part are in contact with each other, and a step of drying the composition for forming a strippable coating film to form the strippable coating film.

### Third Embodiment

FIG. 8 is a top view illustrating a method for peeling off a strippable coating film according to a third embodiment of the present invention. FIG. 9 to FIG. 11 are cross-sectional views and schematic diagram illustrating, in order, the method for peeling off a strippable coating film according to the third embodiment of the present invention.

[First Step]

As shown in FIG. 8, and FIG. 9, a composition for forming a strippable coating film is coated onto a desired region of the surface of the adherend 11 using a coating tool such as an air spray gun, a brush, or a roller (coating step). Thereafter, a trigger part 22 is embedded between the adherend 11 and the composition for forming a strippable coating film (embedding step). The trigger part 22 is made of, for example, a strip-shaped plastic (synthetic resin). The method of embedding the trigger part 22 is not limited, but a method in which the extension portion 2a of the trigger part 22 was pressed toward the surface of the adherend 11 while grasping the extension portion 2a after the composition for forming a strippable coating film was coated can be used. The timing of embedding the trigger part 22 may be immediately after the coating (before the drying) or during the drying of the composition for forming a strippable coating film as long as at least a part of the trigger part 22 is in contact with the adherend 11 and at least a part of the trigger part 22 can be pressed to a position where at least a part of the trigger part 22 is embedded in the composition for forming a strippable coating film. The trigger part 22 cannot be embedded in a state where the composition for forming a strippable coating film is completely dried, and thus the strippable coating film 13 is formed by drying the composition for forming a strippable coating film after the embedding (coating film forming step).

[Second Step]

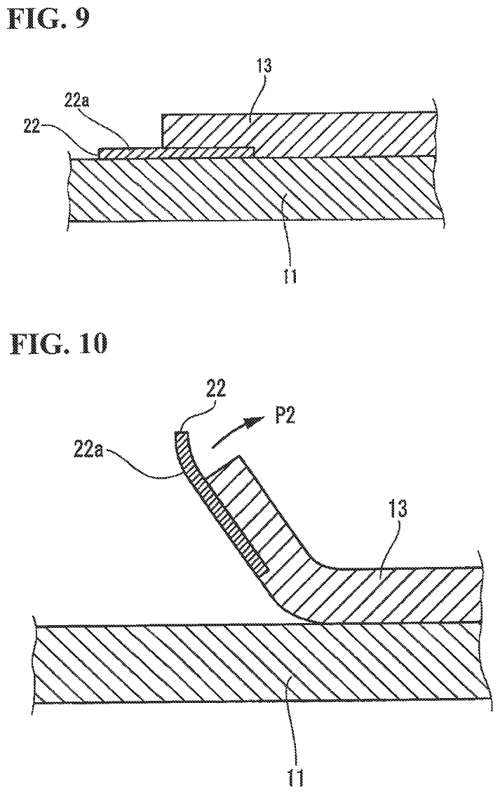

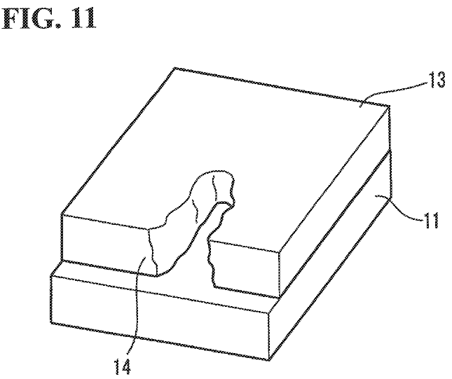

As the second step, as shown in FIG. 10, by pulling an extension portion 22a of the trigger part 22 in a direction indicated by an arrow P2, the trigger part 22 is removed so as to break at least a part of the strippable coating film 13. As shown in FIG. 11, a part of the strippable coating film 13 may be cut off by being broken by the trigger part 22.

[Third Step]

Thereafter, as the third step, the strippable coating film 13 is peeled off from the adherend 11 by using, as a trigger, the broken portion 14 formed by breaking the strippable coating film 13 when the trigger part 22 is removed.

Also in the peeling-off method according to the third embodiment described above, similar to the second embodiment, when the trigger part 22 is removed, a part of the strippable coating film 13 is peeled off from the adherend 11, so that a part of the strippable coating film 13 can be a trigger for the peeling-off. As a result, the work efficiency can be improved.

Further, the fourth embodiment allows for consideration on the position where the trigger part 22 is disposed, with the size, shape, and coating position of the strippable coating film 13 checked, and the trigger for the peeling-off can be formed at an optimum position. Furthermore, the trigger part 22 is put after the composition for forming a strippable coating film is coated, and thus the trigger part 22 has no risk of being embedded entirely, and the work efficiency of forming the strippable coating film 13 can be improved.

In the third embodiment, the strip-shaped trigger part 22 is put. The shape of the trigger part is not limited, but various shapes of the trigger part can be used.

[Article]

Further, an article according to the embodiment of the present invention will be described with reference to FIG. 2 and FIG. 6.

For example, as shown in FIG. 2 or FIG. 6, the article according to the embodiment of the present invention includes: the adherend 11; the trigger part 2, 12 in contact with at least a part of a surface of the adherend 11; and the strippable coating film 13 formed on the adherend 11 and the trigger part 2 or 12, wherein at least a part of the strippable coating film 13 is breakable by removing the trigger part 2 or 12, and the strippable coating film 13 contains an elastomer.

In the article configured in this way, similar to the first to third embodiments, a part of the strippable coating film 13 can be broken when the trigger part 2 or 12 is removed, so that the strippable coating film 13 can be easily peeled off from the adherend by using, as a trigger, the broken portion 14 formed by the breaking.

Next, the trigger part, the strippable coating film, and the adherend that can be used in the present invention will be described in more detail.

<Trigger Part>

The shape of the trigger part in the present embodiment is not limited as long as the trigger part can break at least a part of the strippable coating film, but can be appropriately selected depending on the use of the strippable coating film.

Examples of the shape of the trigger part include a circular shape, a polygonal shape (for example, a triangle, a square, a rectangle, and a polygonal shape having four or more vertices), a tape shape, or a line shape. The shape may be a combination of these, and may further have protrusions. The trigger part is preferably a rectangular, tape-shaped, or linear member. In the present description, a “rectangular shape” may be referred to as a “strip shape”

When the trigger part is linear, for example, it may be a thread-like, string-like, or fibrous member, and specific examples thereof include a nylon string and a metal wire.

The end portion of the trigger part may be subjected to a processing that the end portion has an acute angle, for easily breaking the strippable coating film.

For facilitating removal of the trigger part when at least a part of the strippable coating film is broken by using the trigger part, the trigger part may be subjected to a processing that the trigger part has a round shape or protrusions.

The trigger part may include only a substrate, or may be provided with an adhesive layer on a part or all of the substrate in order to make it easy to determine the position where the trigger part is put.

The adhesive layer is not limited but may be made of a normal adhesive. For example, various adhesives such as acrylic, urethane-based, polyester-based, silicone-based, and rubber-based adhesives can be used.

In addition, when an adhesive layer is provided on the trigger part, a cover such as a film may be put on the surface of the adhesive layer on the extension portion, or the adhesive layer may not be provided on the extension portion, for facilitating the removal of the trigger part.

The substrate of the trigger part in the present embodiment is not limited as long as it can break at least a part of the strippable coating film, but may be cloth, non-woven fabric, paper, resin, metal, or the like, or a combination thereof. The substrate of the trigger part is preferably a resin from the viewpoints of strength and handling. Examples thereof include but not limited to resins such as polyolefin, polyester, polyamide, polycarbonate, polyphenylene oxide, polyimide, polyamideimide, acrylic resin, polyvinyl chloride, polyvinylidene chloride, and polyacrylonitrile.

The thickness of the substrate of the trigger part in the present embodiment is preferably 10 μm or more, more preferably 20 μm or more, and still more preferably 30 μm or more. The thickness of the substrate is preferably 500 μm or less, more preferably 400 μm or less, and still more preferably 300 μm or less. The thickness of 10 μm or more prevents the trigger part from breaking and makes the handling excellent. The thickness of 500 μm or less makes it easy to remove the trigger part and makes the workability excellent.

The tensile elastic modulus of the trigger part is preferably 0.01 GPa or more, more preferably 0.1 GPa or more, and still more preferably 1 GPa or more. The tensile elastic modulus is preferably 300 GPa or less, more preferably 200 GPa or less, and still more preferably 100 GPa or less. A tensile elastic modulus of 0.01 GPa or more is preferred since the trigger part is prevented from breaking and it is easy to break at least part of the strippable coating film. A tensile elastic modulus of 300 GPa or less is preferred since the workability is excellent.

Further, the tensile elastic modulus of the trigger part is preferably larger than the tensile elastic modulus of the strippable coating film. This allows at least a part of the strippable coating film to be easily broken by the trigger part, and thus the workability is excellent.

The tensile elastic modulus of the trigger part can be measured by the method described in Examples.

<Strippable Coating Film>

The strippable coating film of the present embodiment preferably has a tensile elastic modulus of 0.01 MPa or more. When the tensile elastic modulus of the strippable coating film is 0.01 MPa or more, the strength of the strippable coating film is sufficiently high, and the antifouling effect can be further maintained. In addition, deformation of the strippable coating film due to an external force is prevented. The elastic modulus of the strippable coating film is more preferably 0.05 MPa or more, and still more preferably 0.1 MPa or more. The elastic modulus of the strippable coating film is, for example, 1000 MPa or less from the viewpoint of work of peeling off the strippable coating film.

The elastic modulus of the strippable coating film can be measured by the method described in Examples.

As the thickness of the strippable coating film, any appropriate thickness can be adapted depending on the use, usage environment, and the like. The thickness of the strippable coating film is preferably 10 μm to 5000 μm. When the thickness of the strippable coating film is 10 μm or more, the strippable coating film is easy to be peeled off without breaking when the strippable coating film is tried to be peeled off. When the thickness of the strippable coating film is 5000 μm or less, the work efficiency of preparing the strippable coating film is excellent.

The thickness of the strippable coating film can be measured using, for example, RI-205 manufactured by PEACOCK.

The adhesive force of a strippable coating film to SUS304 2B shirring finish (hereinafter referred to as SUS) is used as an index showing the difficulty of being peeled off from an adherend when the strippable coating film is used.

The adhesive force of the strippable coating film to SUS according to the present embodiment is preferably 50 N/20 mm or less, preferably 30 N/20 mm or less, still more preferably 20 N/20 mm or less, even more preferably 10 N/20 mm or less, and most preferably 1 N/20 mm or less.

<Composition for Forming Strippable Coating Film>

A composition for forming the strippable coating film (hereinafter, may be referred to as a strippable coating film forming composition) may contain a resin component and a solvent. As the resin component, for example, elastomers such as a rubber (thermosetting elastomer) and a thermoplastic elastomer can be used. Alternatively, an emulsion or hot melt can be used.

As the rubber, an acrylic rubber, a diene-based rubber, a butyl rubber, a nitrile rubber, a hydrogenated nitrile rubber, a fluorine rubber, a silicone rubber, an ethylene propylene rubber, a chloroprene rubber, a urethane rubber, and an epichlorohydrin rubber can be used. In particular, an acrylic rubber, a diene-based rubber, or a urethane rubber is preferably used. As the diene-based rubber, a natural rubber, an isoprene rubber, a butadiene rubber, a styrene butadiene rubber, a chloroprene rubber, and an acrylonitrile butadiene rubber can be used, and a styrene butadiene rubber is preferably used.

As the thermoplastic elastomer, monovinyl-substituted aromatic compound-based thermoplastic elastomers such as an acrylic thermoplastic elastomer and a styrene-based thermoplastic elastomer can be used.

Examples of the acrylic thermoplastic elastomer include block copolymers of PMMA (polymethylmethacrylate) and an acrylic acid alkyl ester. Examples of the acrylic acid alkyl ester include butyl acrylate, 2-ethylhexyl acrylate, and octyl acrylate.

As the styrene-based thermoplastic elastomer, for example, SBS (styrene/butadiene/styrene block copolymer), SIS (styrene/isoprene/styrene block copolymer), SEBS (styrene/ethylene/butylene/styrene block copolymer), SEPS (styrene/ethylene/propylene/styrene block copolymer), and SEEPS (styrene/ethylene/ethylene/propylene/styrene block copolymer) can be used.

When the resin component is a styrene-based thermoplastic elastomer, the tensile elastic modulus and the adhesive force can be adjusted by adjusting the content ratio of styrene in the resin component. The content ratio of styrene is preferably 20 mass % to 40 mass %, more preferably 22 mass % to 35 mass %, and still more preferably 25 mass % to 33 mass %.

Further, for the same purpose, the composition for forming a strippable coating film may contain a compound containing a polar group. Examples of such a compound include a resin containing the polar group, a silane coupling agent, and a silicone oil. Examples of the resin containing the polar group include an ionomer, a rosin resin, and a silicone resin. The content of these compounds with respect to the resin component in the composition for forming a strippable coating film is preferably 5 mass % to 95 mass %, more preferably 10 mass % to 90 mass %, still more preferably 15 mass % to 80 mass %, particularly preferably 20 mass % to 70 mass %, and most preferably 25 mass % to 60 mass %.

The content ratio of the resin component in the composition for forming a strippable coating film is preferably 5 mass % to 95 mass %, more preferably 10 mass % to 90 mass %, still more preferably 15 mass % to 80 mass %, particularly preferably 20 mass % to 70 mass %, and most preferably 25 mass % to 60 mass %.

Examples of the emulsion include a urethane emulsion and an acrylic emulsion.

Examples of the hot melt include an ethylene vinyl acetate resin.

The composition for forming a strippable coating film may contain any suitable other additives as long as the effect of the present invention is not impaired. Examples of such other additives include thickeners (for example, association type, synthetic polymer type, and alkaline thickening type), colorants, ultraviolet absorbers, light stabilizers, antioxidants, defoamers, and fillers.

As the solvent, for example, aromatic hydrocarbons such as benzene, toluene, xylene, ethylbenzene, and trimethylbenzene, aliphatic hydrocarbons such as hexane and heptane, esters such as ethyl acetate and vinyl acetate, ethers such as dioxane and diethyl ether, alcohols such as ethanol, isopropanol and n-butanol, ketones such as acetone, diethyl ketone, and methyl isobutyl ketone, and water can be used. These solvents may be used alone or in combination of two or more thereof.

The content ratio of the solvent in the composition for forming a strippable coating film is preferably 5 mass % to 95 mass %, more preferably 10 mass % to 90 mass %, still more preferably 20 mass % to 85 mass %, particularly preferably 30 mass % to 80 mass %, and most preferably 40 mass % to 75 mass %.

The strippable coating film may be used as an undercoat layer, and an antifouling layer, a rust preventive paint, a hard coat, or the like may be further provided on the strippable coating film.

As the composition for forming the antifouling layer, for example, a silicone-based resin or a fluoropolymer can be used.

The rust preventive paint and the hard coat antifouling layer may contain any suitable other additives as long as the effect of the present invention is not impaired. Examples of such other additives include ultraviolet absorbers, light stabilizers, and fillers.

The strippable coating film can be formed by coating the composition for forming a strippable coating film onto an adherend and drying the same.

For the coating method, the composition for forming a strippable coating film can be coated directly onto the adherend by a known coating method such as spray, brush coating, roller, curtain flow, roll, dip, and coater.

For a drying method, for example, the composition for forming a strippable coating film can be dried at a temperature of 0° C. to 250° C. (preferably a temperature of room temperature (23° C.) to 180° C., and more preferably a temperature of room temperature (23° C.) to 160° C.) for 2 minutes to 12 hours.

<Adherend>

Examples of a typical material used for the surface of the adherend include gel coat (acrylic polymer/polystyrene, etc.), epoxy resins, enamel (acrylic polymer, etc.), various metals (aluminum, aluminum alloys such as aluminum bronze, stainless steel, and titanium), antifouling paint, polyurethane, polyethylene, polypropylene, polycarbonate, polyethylene terephthalate, polyacetal resins, and ABS resins.

Specific examples of the adherend include various structures such as metal products, woodwork products, plastic products, glass products, buildings (inner and outer walls, floors, and ceilings), electronic equipment, and transportation equipment (for example, vehicles such as automobiles, motorcycles and railroads, and ships).

### EXAMPLES

Hereinafter, the present invention will be specifically described with reference to Examples, but the present invention is not limited to these Examples.

(Preparation of Composition for Forming Strippable Coating Film)

100 parts by mass of a polyurethane (Superflex 150, manufactured by DKS Co. Ltd.), 0.7 part by mass of a thickener (SN Thickener 660T, manufactured by SAN NOPCO LIMITED), and 1 part by mass of a defoamer (BYK-024, manufactured by Additives & Instruments) were mixed to prepare a composition for forming a strippable coating film. The solid content concentration was about 34 mass %.

### Example 1

A stainless steel (SUS304 2B shirring finish) plate was prepared as an adherend, and No. 1 nylon string (6-100-11, manufactured by TOHO Co., Ltd) was put, as a thread-like trigger part, at the end portion of the coating surface of the adherend as shown in FIG. 1.

The composition for forming a strippable coating film 1 was coated with a brush to give a film thickness of about 500 μm, and was allowed to stand and dried in a room at about 23° C. to form a strippable coating film, and the article according to the embodiment of the present invention as shown in FIG. 2 was obtained.

The extension portion of the trigger part was picked off, pulled up and removed, and the strippable coating film was broken as shown in FIG. 4 to form a broken portion as a trigger for the peeling-off.

The strippable coating film was peeled off from the adherend by picking off the broken portion of the strippable coating film.

### Example 2

A stainless steel (SUS304 2B shirring finish) plate was prepared as an adherend, and No. 1 nylon string (6-100-11, manufactured by TOHO Co., Ltd) was put, as a thread-like trigger part, from one end portion to the other end portion on the coating surface of the adherend as shown in FIG. 5.

The composition for forming a strippable coating film 1 was coated with a brush to give a film thickness of about 500 μm, and was allowed to stand and dried in a room at about 23° C. the composition for forming a strippable coating film 1 to form a strippable coating film, and thus the article according to the embodiment of the present invention as shown in FIG. 6 was obtained.

The extension portion of the trigger part was picked off, pulled up and removed, and the strippable coating film was broken into two as shown in FIG. 7 to form a broken portion as a trigger for the peeling-off.

The strippable coating film was peeled off from the adherend by picking off the broken portion of the strippable coating film.

### Comparative Example 1

A stainless steel plate (SUS304 2B shirring finish) was prepared as an adherend, and a thread-like trigger part was not put. The composition for forming a strippable coating film 1 was coated with a brush to give a film thickness of about 500 μm, and was allowed to stand and dried in a room at about 23° C. to form a strippable coating film.

The strippable coating film was attempted to be peeled off, but the strippable coating film could not be peeled off from the adherend.

(Tensile Elastic Modulus)

The tensile elastic modulus of the trigger part and the strippable coating film was evaluated by using AUTOGRAPH AGS-J/H, manufactured by Shimadzu Corporation, at a tensile speed of 300 mm/min. As the tensile elastic modulus, the maximum tensile elastic modulus at the first rise of the stress-strain curve was adopted.

(Easiness of Peeling Off Strippable Coating Film)

Easiness of peeling off the strippable coating film was evaluated according to the following evaluation criteria.

◯ (good): the strippable coating film could be easily started to be peeled off from the adherend.

× (poor): it was difficult or impossible to peel off the strippable coating film from the adherend.

Table 1 below shows the kinds and putting methods (timing and position) of the trigger part, the trigger when the strippable coating film was peeled off, easiness of the peeling-off, and the evaluation result of the tensile elastic modulus (of the trigger part and the strippable coating film), for Examples and Comparative Example.

TABLE 1

| | | | | | Trigger when | Tensile elastic | Tensile elastic | |
|---|---|---|---|---|---|---|---|---|
| | | | Timing of | Position of | strippable | modulus | modulus (N/mm²) | |
| | | Trigger | putting | putting | coating film | (N/mm²) | of strippable | Easiness of |
| | | part | trigger part | trigger part | was peeled off | of trigger part | coating film | peeling-off |
| Example | 1 | Nylon | Before | End portion | Coating film | 2200 | 57 | ◯ |
| | | string | coating | | | | | |
| | 2 | Nylon | Before | End portion to | Coating film | 2200 | 57 | ◯ |
| | | string | coating | end portion | | | | |
| Comparative | 1 | — | — | — | Coating film | — | 57 | X |
| Example | | | | | | | | |

In Examples 1 and 2, the strippable coating film was peeled off from the adherend by using, as a trigger, the broken portion formed by removing the trigger part, so that the evaluation result of the easiness of the peeling-off was excellent.

On the other hand, in Comparative Example 1 in which the trigger part was not put, the strippable coating film could not be peeled off because of no trigger for the peeling-off and the evaluation result of the easiness of the peeling-off was poor.

Although preferred embodiments of the present invention have been described above, the present invention is not limited to the above embodiments, and various modifications and substitutions can be added to the above embodiments without departing from the scope of the present invention.

Although the present invention has been described in detail with reference to specific embodiments, it will be apparent to those skilled in the art that various changes and modifications can be made without departing from the spirit and the scope of the present invention.

The present application is based on a Japanese Patent Application No. 2018-242673, filed on Dec. 26, 2018, the contents of which are incorporated herein by reference.

### INDUSTRIAL APPLICABILITY

The present invention allows for providing a peeling-off method and an article capable of improving the workability of peeling off a coating film that is easily strippable into a sheet shape.

### REFERENCE SIGNS LIST

11 adherend

2, 12, 22 trigger part

2a, 12a, 22a extension portion

13 strippable coating film

14 broken portion

1. A method for peeling off a strippable coating film formed on a surface of an adherend, comprising:
a first step of preliminarily putting a trigger part in contact with at least a part of the surface of the adherend between the strippable coating film and the adherend;
a second step of removing the trigger part so as to break at least a part of the strippable coating film; and
a third step of peeling off the strippable coating film by using, as a trigger, a broken portion of the strippable coating film.

2. The method for peeling off a strippable coating film according to claim 1, wherein
the first step includes:
a step of putting the trigger part on the surface of the adherend;
a step of coating a composition for forming a strippable coating film onto the surface of the adherend so as to cover at least a part of the trigger part; and
a step of drying the composition for forming a strippable coating film to form the strippable coating film.

3. The method for peeling off a strippable coating film according to claim 1, wherein
the first step includes:
a step of coating a composition for forming a strippable coating film onto the surface of the adherend;
a step of embedding the trigger part in the composition for forming a strippable coating film such that the adherend and at least a part of the trigger part are in contact with each other; and
a step of drying the composition for forming a strippable coating film to form the strippable coating film.

4. The method for peeling off a strippable coating film according to claim 1, wherein the trigger part is put while an extension portion is left in the first step.

5. The method for peeling off a strippable coating film according to claim 1, wherein the trigger part is strip-shaped, tape-shaped, or linear.

6. The method for peeling off a strippable coating film according to claim 1, wherein a tensile elastic modulus of the trigger part is larger than a tensile elastic modulus of the strippable coating film.

7. The method for peeling off a coating film according to claim 1, wherein the strippable coating film contains an elastomer.

8. The method for peeling off a coating film according to claim 1, wherein the strippable coating film is broken into two or more by the second step.

9. An article comprising:
an adherend;
a trigger part in contact with at least a part of the surface of the adherend; and
a strippable coating film formed on the adherend and the trigger part, wherein
at least a part of the strippable coating film is breakable by removing the trigger part, and the strippable coating film contains an elastomer.
